(19) United States
(12) Patent Application Publication
(10) Pub. No.: US 2019/0349364 A1
(43) Pub. Date: Nov. 14, 2019

(54) TECHNIQUES OF USING FINGERPRINTS TO AUTHENTICATE KVM USERS AT SERVICE PROCESSOR

(71) Applicant: American Megatrends, Inc., Norcross, GA (US)

(72) Inventors: Samvinesh Christopher, Suwanee, GA (US); Baskar Parthiban, Johns Creek, GA (US); Satheesh Thomas, Dunwoody, GA (US)

(21) Appl. No.: 15/978,836

(22) Filed: May 14, 2018

(51) Int. Cl. H04L 29/06; G06K 9/00

(52) U.S. Cl. CPC H04L 63/0861; G06K 9/00087

(57) ABSTRACT

In an aspect of the disclosure, a method, a computer-readable medium, and an apparatus are provided. The apparatus may be a service processor. The service processor receives, from a device remotely, a first fingerprint data record of a user and a request to receive a KVM console flow of a host of the service processor. The service processor further authenticates the user based on the first fingerprint data record. The service processor then redirects the KVM console flow to the device when the user is authenticated.

### BACKGROUND

### Field

The present disclosure relates generally to embedded-system devices, and more particularly, to techniques using fingerprint data of a user generated at a remote device to authenticate the user at a service processor for accessing a keyboard, video and mouse (KVM) console flow of a host of the service processor.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

A BMC may require a firmware image to make them operational. “Firmware” is software that is stored in a read-only memory (ROM) (which may be reprogrammable), such as a ROM, PROM, EPROM, EEPROM, etc.

A BMC may be considered as an embedded-system device or a service processor. A service processor may provide various functionalities for managing or serving a host. For example, a service processor may provide a rich set of KVM redirection features for a host of the service processor. Further, a remote client machine accessing the KVM redirection features of the service processor may be equipped with a fingerprint reader. Thus, there is a need to integrate security features provided by the fingerprint reader for accessing the KVM redirection features available at the service processor.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a service processor. The service processor receives, from a device remotely, a first fingerprint data record of a user and a request to receive a KVM console flow of a host of the service processor. The service processor further authenticates the user based on the first fingerprint data record. The service processor then redirects the KVM console flow to the device when the user is authenticated.

### BRIEF DESCRIPTION OF THE DRAWINGS

FIG. 1 is a diagram illustrating an embedded-system device.

FIG. 2 is a diagram 100 illustrating an authentication sequence for KVM redirection.

FIG. 3 is a flow chart of a method (process) for authenticating a user requesting KVM redirection access.

FIG. 4 is a diagram illustrating an example of a hardware implementation for an apparatus employing a processing system.

FIG. 5 shows a computer architecture for a computer.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

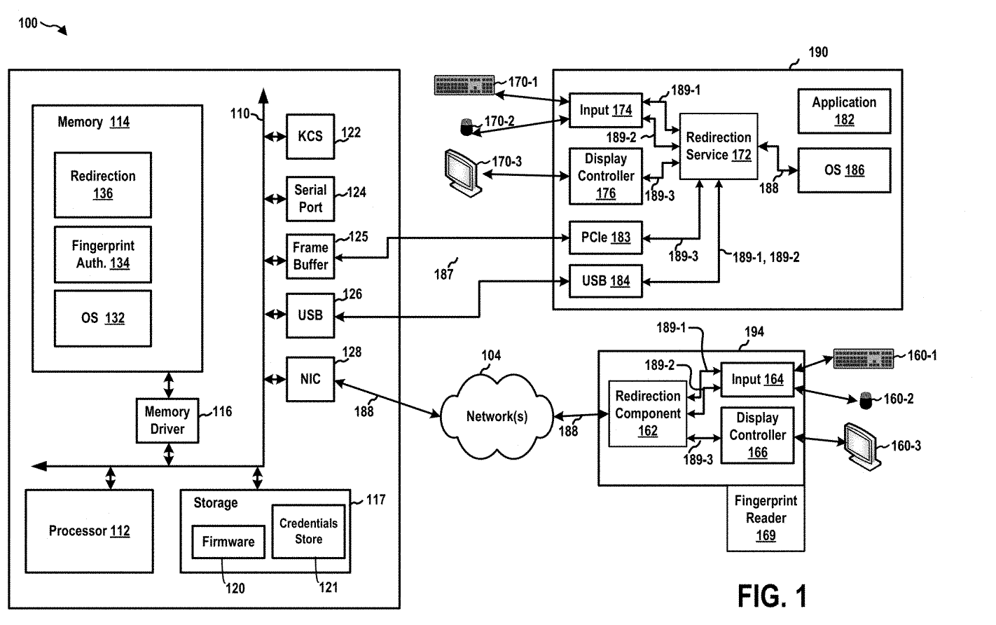

FIG. 1 is a diagram 100 illustrating a service processor 102. The service processor 102 has, among other components, a processing unit 112, a memory 114, a memory driver 116, a storage 117, a keyboard controller style (KCS) interface 122, a serial port 124, a frame buffer 125, a Universal Serial Bus (USB) connection component 126, and a network interface card 128. Further, the service processor 102 may support IPMI and may provide an IPMI interface. The IPMI interface may be implemented over communication interfaces such as the KCS interface 122, the serial port 124, the USB connection component 126, the network interface card 128, etc. The memory 114, the processing unit 112, the memory driver 116, the storage 117, the KCS interface 122, the serial port 124, the frame buffer 125, the USB connection component 126, the network interface card 128, etc., may be in communication with each other through a communication channel 110 such as a bus architecture. The service processor 102 may be in communication with, e.g., through communication interfaces or the IPMI interface, a host computer 190 and/or a network device 194. The communication between the BMC and the network device 194 may be carried over a network 104. The BMC may manage the host computer 190.

The storage 117 of the service processor 102 may store system firmware 120. When the processing unit 112 executes the system firmware 120, the processing unit 112 loads code and data of the system firmware 120 into the memory 114. This example shows that the system firmware 120 provides in the memory 114, among other components, an OS 132, a fingerprint authentication component 134, and a redirection component 136.

The host computer 190 may include, among other components, a host OS 186, a user application 182, a redirection service 172, an input component 174, a display controller 176, a Peripheral Component Interconnect Express (PCIe) component 184, and a USB connection component 184. The host OS 186 generates a KVM console flow 188 and sends the KVM console flow 188 to a host console 170 (passing through a redirection service 172 as described supra). For example, the host console 170 may include a keyboard 170-1, a pointing device 170-2, and a display 170-3. The KVM console flow 188 may be bi-directional, thus providing bi-directional communication between the host OS 186 and the host console 170. The KVM console flow 188 may include a keyboard stream 189-1, a mouse stream 189-2, and a video stream 189-3.

More specifically, the host OS 186 sends keyboard data to the input component 174 through the keyboard stream 189-1 and sends pointing device data to the input component 174 through the mouse stream 189-2. The input component 174 generates keyboard signals in accordance with the keyboard data and transmits the keyboard signals to the keyboard 170-1. The input component 174 generates pointing device signals in accordance with the pointing device data and transmits the pointing device signals to the pointing device 170-2. Further, the keyboard 170-1 and the pointing device 170-2 may transmit keyboard signals and pointing device signals to the input component 174, respectively. The input component 174 generates keyboard data and pointing device data accordingly and sends the data to the host OS 186. Further, the display controller 176 reads video data through the video stream 189-3 provided by the host OS 186, which, for example, may access a frame buffer of the host computer 190 to obtain video data. The display controller 176 generates video signals in accordance with the video data and transmits the video signals to the display 170-3. The display 170-3 displays one or more screen displays/images in accordance with the video signals.

In certain configurations, the host computer 190 also includes a redirection service 172. The redirection service 172 may intercept or otherwise receive the KVM console flow 188 destined to the host console 170 and sent from the host OS 186. The redirection service 172 may redirect the KVM console flow 188 to other destination consoles in addition to the host console 170. Alternatively, the redirection service 172 may choose not to allow the KVM console flow 188 to be sent to the host console 170; as such, the KVM console flow 188 is only directed to the other destination consoles.

In this example, the redirection service 172 directs the KVM console flow 188 to the redirection component 136 of the service processor 102. The redirection service 172 and the redirection component 136 may utilize the USB connection component 184 and the PCIe component 183 to establish the redirection communication. In particular, the redirection service 172 sends the keyboard stream 189-1 and the mouse stream 189-2 to the redirection component 136 through a USB connection established between the USB connection component 184 and the USB connection component 126. The redirection service 172 may writes video stream 189-3 directly to the frame buffer 125 on the service processor 102, for example, through the PCIe component 183.

Further, the redirection component 136 at the service processor 102 is configured to redirect, through the network interface card 128 and over the network 104, the entire KVM console flow 188 to a device redirection component 162 of the network device 194. The network device 194 further includes, among other components, an input component 164, a display controller 166, and a fingerprint reader 169. The input component 164 may communicate keyboard signals and pointing device signals with a keyboard 160-1 and a pointing device 160-2. The display controller 166 may communicate video signals with a display 160-3. The keyboard 160-1, the pointing device 160-2, and the display 160-3 collectively may be considered as a client console 160. The device redirection component 162 directs the keyboard stream 189-1 and the mouse stream 189-2 to the input component 164, which in turn redirects the keyboard stream 189-1 and the mouse stream 189-2 to the keyboard 160-1 and the pointing device 160-2, respectively. The device redirection component 162 directs the video stream 189-3 (e.g., through a frame buffer of the network device 194) to the display controller 166, which in turn redirects the video stream 189-3 to the display 160-3.

The device redirection component 162 on the network device 194 initially needs to establish a redirection session with the redirection component 136 at the service processor 102 in order to receive the KVM console flow 188. To establish a redirection session, the device redirection component 162 sends credentials of a user of the network device 194 to the redirection component 136 through the network 104. Upon receiving the credentials, the redirection component 136 authenticates the user based on the received credentials. For example, the storage 117 of the service processor 102 may contain a credentials store 121 (e.g., a database), which stores credentials of all the authorized users. In another example, the credentials store 121 may be located at a remote storage device in the network 104. The redirection component 136 checks the received credentials of a particular user with the stored credentials of the same user to authenticate the particular user. When the received credentials match the stored credentials, the redirection component 136 can determine that the particular user has been successfully authenticated and may, accordingly, establish a redirection session with the network device 194.

In one example, the user credentials may be a pair of user name and password. A user of the network device 194 may input, through the client console 160, the user name and password.

In another example, the user credentials may be one or more fingerprints of a user. The fingerprint reader 169 of the network device 194 scans a fingerprint of a particular user and generates fingerprint data record representing the fingerprint. The fingerprint reader 169 sends the fingerprint data to the device redirection component 162, which sends the fingerprint data to the redirection component 136 of the service processor 102 through the network 104. Upon receiving the fingerprint data, the redirection component 136 may utilize the fingerprint authentication component 134 to authenticate the particular user. In particular, the credentials store 121 may also contain fingerprint data records representing fingerprints of authorized users. Therefore, the fingerprint authentication component 134 compares the received fingerprint data record with the stored fingerprint data records to determine whether the received fingerprint data record matches one of the stored fingerprint data records. Based on the comparison result, the fingerprint authentication component 134 may determine that the fingerprint scanned at the fingerprint reader 169 matches a fingerprint of an authorized user. Accordingly, the redirection component 136 can determine that the particular user has been successfully authenticated and may, accordingly, establish a redirection session with the network device 194.

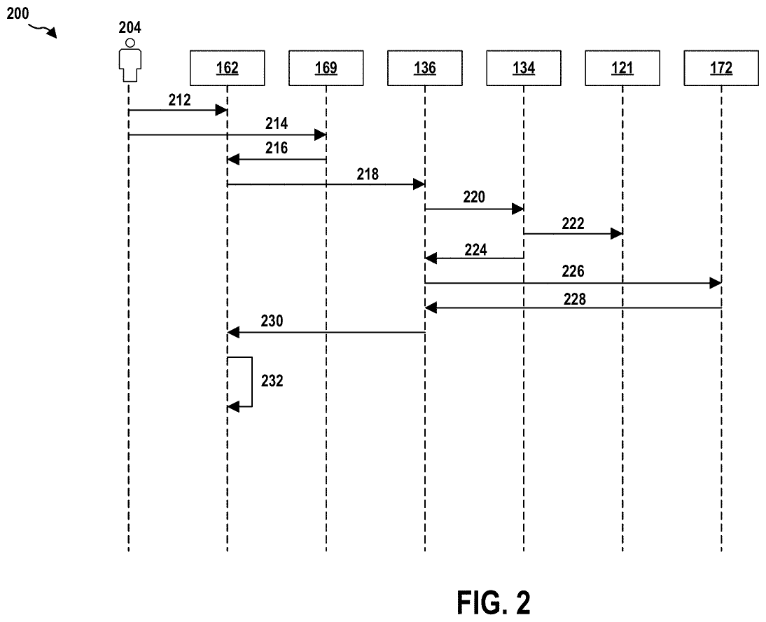

FIG. 2 is a diagram 100 illustrating an authentication sequence for KVM redirection. At operation 212, a user 204 interacts with a user interface provided by the device redirection component 162 of the network device 194 to access KVM redirection from the host computer 190. The device redirection component 162 may prompt the user 204 to enter his/her user credentials such as user name and password. Further, the device redirection component 162 may allow the user 204 to provide fingerprint as credentials. At operation 214, in this example, the user 204 uses the fingerprint reader 169 to scan his/her fingerprint(s). The fingerprint reader 169 accordingly generates a fingerprint data record (i.e., data) representing the scanned fingerprint(s). At operation 216, the fingerprint reader 169 sends the fingerprint data record to the device redirection component 162. At operation 218, the device redirection component 162 of the network device 194 sends to the redirection component 136 a request to access KVM redirection from the host computer 190 and user credentials of the requesting user. In this example, the user credentials are the fingerprint data record generated from scanning fingerprint(s) of the user 204. Upon receiving the user credentials, the redirection component 136 initially authenticates the user requesting the KVM redirection. In this example, at operation 220, the redirection component 136 sends the received fingerprint data record to the fingerprint authentication component 134. at operation 222, the fingerprint authentication component 134 matches/compares the received fingerprint data record with the fingerprint data records stored in the credentials store 121. At operation 224, the fingerprint authentication component 134 sends the matching result to the redirection component 136.

When the matching result indicates a user whose fingerprint data record stored at the credentials store 121 matches the received fingerprint data record, the redirection component 136 determines that the user is authenticated. Accordingly, the redirection component 136 establishes a redirection session with the redirection service 172 and requests to open a KVM console flow with the redirection service 172. At operation 228, the redirection service 172 sends a KVM console flow to the redirection component 136. At operation 230, the redirection component 136 sends the received KVM console flow to the device redirection component 162. At operation 232, the device redirection component 162, using the KVM console flow, sends the video stream 189-3 (generated at the host computer 190) to the display controller 166 for displaying at the display 160-3. The input component 164 receives input signals from the keyboard 160-1 and/or the pointing device 160-2. The input component 164 generates the keyboard stream 189-1 and the mouse stream 189-2 based on the input signals and sends the keyboard stream 189-1 and the mouse stream 189-2 to device redirection component 162, which sends the keyboard stream 189-1 and the mouse stream 189-2 and the redirection component 136, which sends the keyboard stream 189-1 and the mouse stream 189-2 and the redirection service 172.

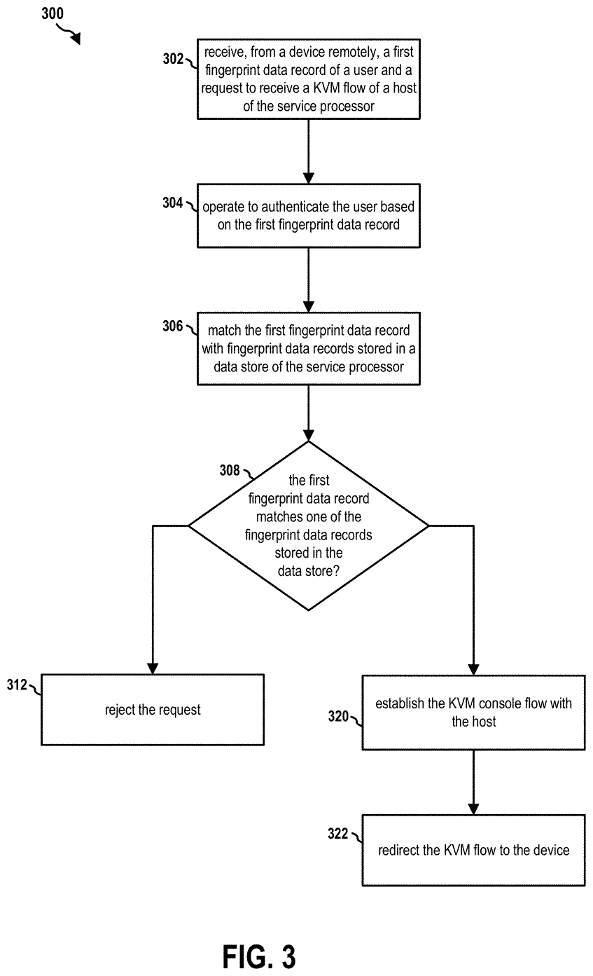

FIG. 3 is a flow chart 300 of a method (process) for authenticating a user requesting KVM redirection access. The method may be performed by a service processor (e.g., the service processor 102 and the apparatus 102′).

At operation 302, the service processor receives, from a device (e.g., the network device 194) remotely, a first fingerprint data record of a user and a request to receive a KVM console flow (e.g., the KVM console flow 188) of a host (e.g., the host computer 190) of the service processor.

At operation 304, the service processor operates to authenticate the user based on the first fingerprint data record. At operation 306, the service processor matches the first fingerprint data record with fingerprint data records stored in a data store (e.g., the credentials store 121) of the service processor.

At operation 308, the service processor determines whether the first fingerprint data record matches one of the fingerprint data records stored in the data store.

When there is no match, at operation 312, the service processor determines that the user is not authenticated and rejects the user's request received in operation 302.

When the service processor finds that the first fingerprint data record matches the fingerprint data record of a particular user stored in the data store, the service processor can determine and confirm the identity of the user. That is, the user sending the request in operation 302 is authenticated.

At operation 320, the service processor establishes the KVM console flow with the host. At operation 322, the service processor redirects the KVM console flow to the device. In certain configurations, the data store is at a local storage device of the service processor. In certain configurations, the device includes a fingerprint reader. The fingerprint reader generates the first fingerprint data record based on a scan of a finger of the user.

In certain configurations, to redirect the KVM console flow, the service processor receives video data generated at the host through a video stream established between the host and the service processor and sending the video stream to the device through a video stream established between the service processor and the device. The service processor also receives mouse data generated at the device through a mouse stream established between the device and the service processor and sending the mouse data to the host through a mouse stream established between the service processor and the host. The service processor receives keyboard data generated at the device through a keyboard stream established between the device and the service processor and sending the keyboard data to the host through a keyboard stream established between the service processor and the host.

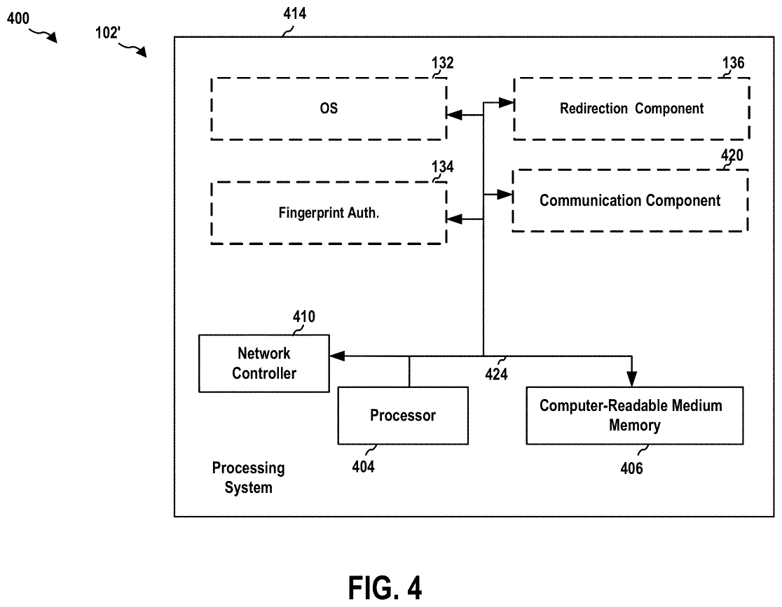

FIG. 4 is a diagram 400 illustrating an example of a hardware implementation for an apparatus 102′ employing a processing system 414. The apparatus 102′ may implement the service processor 102. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware components, represented by the processor 404, the OS 132, the fingerprint authentication component 134, the redirection component 136, and the computer-readable medium/memory 406. In particular, the computer-readable medium/memory 406 may include the memory 114 and the storage 117. The bus 424 may also link various other circuits such as timing sources, peripherals, voltage regulators, and power management circuits, which are well known in the art, and therefore, will not be described any further.

The processing system 414 may be coupled to a network controller 410. The network controller 410 provides a means for communicating with various other apparatus over a network. The network controller 410 receives a signal from the network, extracts information from the received signal, and provides the extracted information to the processing system 414, specifically a communication component 420 of the apparatus 102′. In addition, the network controller 410 receives information from the processing system 414, specifically the communication component 420, and based on the received information, generates a signal to be sent to the network. The processing system 414 includes a processor 404 coupled to a computer-readable medium/memory 406. The processor 404 is responsible for general processing, including the execution of software stored on the computer-readable medium/memory 406. The software, when executed by the processor 404, causes the processing system 414 to perform the various functions described supra for any particular apparatus. The computer-readable medium/memory 406 may also be used for storing data that is manipulated by the processor 404 when executing software. The processing system further includes at least one of the OS 132, the fingerprint authentication component 134, and the redirection component 136. The components may be software components running in the processor 404, resident/stored in the computer readable medium/memory 406, one or more hardware components coupled to the processor 404, or some combination thereof.

The apparatus 102′ may be configured to include means for performing each of the operations described supra referring to FIG. 3. The aforementioned means may be one or more of the aforementioned components of the apparatus 102′ and/or the processing system 414 of the apparatus 102′ configured to perform the functions recited by the aforementioned means.

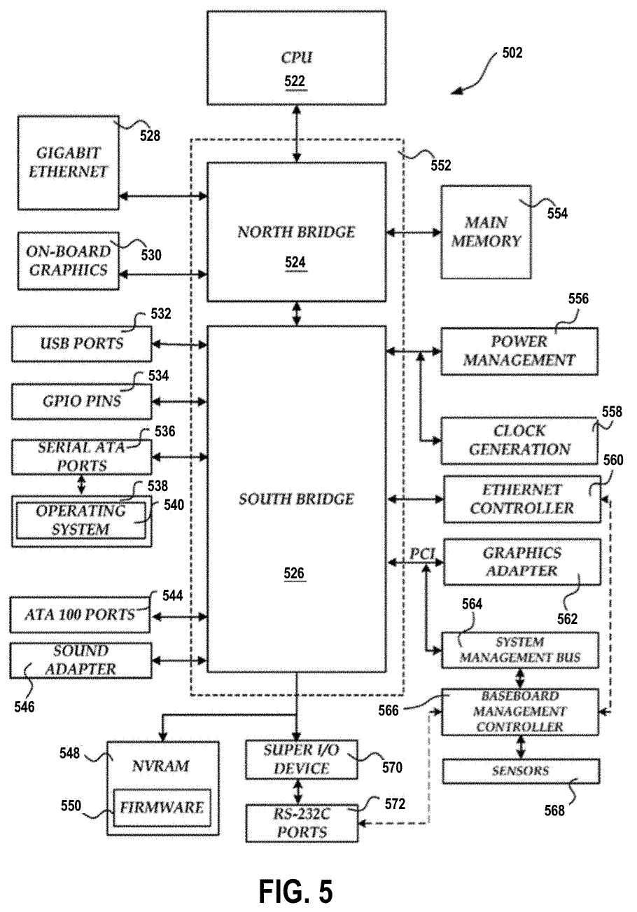

FIG. 5 and the following discussion are intended to provide a brief, general description of one suitable computing environment in which aspects of the embodiments described herein may be implemented. In particular, FIG. 5 shows a computer architecture for a computer 502 that may be utilized to embody the host computer 190, as described supra. It should be appreciated that the computer architecture shown in FIG. 5 is merely illustrative and that other types of computers and computing devices may also be utilized to implement aspects of the embodiments presented herein.

While aspects presented herein include computer programs that execute in conjunction with the execution of an operating system, those skilled in the art will recognize that the embodiments may also be implemented in combination with other program modules and/or hardware devices. As described herein, computer programs include routines, programs, components, data structures, and other types of structures that perform particular tasks or implement particular abstract data types. Moreover, those skilled in the art will appreciate that the embodiments described herein may be practiced with other computer system configurations, including hand-held devices, multiprocessor systems, microprocessor-based or programmable consumer electronics, minicomputers, mainframe computers, and the like. The embodiments described herein may also be practiced in distributed computing environments where tasks are performed by remote processing devices that are linked through a communications network. In a distributed computing environment, program modules may be located in both local and remote memory storage devices.

The computer 502 shown in FIG. 5 includes a baseboard, or “motherboard,” which is a printed circuit board to which a multitude of components or devices may be connected by way of a system bus or other electrical communication path. In one illustrative embodiment, a CPU 522 operates in conjunction with a chipset 552. The CPU 522 is a standard central processor that performs arithmetic and logical operations necessary for the operation of the computer. The server computer 502 may include a multitude of CPUs 522.

The chipset 552 includes a north bridge 524 and a south bridge 526. The north bridge 524 provides an interface between the CPU 522 and the remainder of the computer 502. The north bridge 524 also provides an interface to a random access memory (“RAM”) used as the main memory 554 in the computer 502 and, possibly, to an on-board graphics adapter 530. The north bridge 524 may also include functionality for providing networking functionality through a gigabit Ethernet adapter 528. The gigabit Ethernet adapter 528 is capable of connecting the computer 502 to another computer via a network. Connections which may be made by the network adapter 528 may include LAN or WAN connections. LAN and WAN networking environments are commonplace in offices, enterprise-wide computer networks, intranets, and the internet. The north bridge 524 is connected to the south bridge 526.

The south bridge 526 is responsible for controlling many of the input/output functions of the computer 502. In particular, the south bridge 526 may provide one or more USB ports 532, a sound adapter 546, an Ethernet controller 560, and one or more GPIO pins 534. The south bridge 526 may also provide a bus for interfacing peripheral card devices such as a graphics adapter 562. In one embodiment, the bus comprises a PCI bus. The south bridge 526 may also provide a system management bus 564 for use in managing the various components of the computer 502. Additional details regarding the operation of the system management bus 564 and its connected components are provided below.

The south bridge 526 is also operative to provide one or more interfaces for connecting mass storage devices to the computer 502. For instance, according to an embodiment, the south bridge 526 includes a serial advanced technology attachment (“SATA”) adapter for providing one or more SATA ports 536 and an ATA 100 adapter for providing one or more ATA 100 ports 544. The SATA ports 536 and the ATA 100 ports 544 may be, in turn, connected to one or more mass storage devices such as the SATA disk drive 538 storing an operating system 540 and application programs.

As known to those skilled in the art, an operating system 540 comprises a set of programs that control operations of a computer and allocation of resources. An application program is software that runs on top of the operating system software, or other runtime environment, and uses computer resources to perform application specific tasks desired by the user. According to one embodiment of the invention, the operating system 540 comprises the LINUX operating system. According to another embodiment of the invention the operating system 540 comprises an operating system within the WINDOWS family of operating systems from MICROSOFT CORPORATION. According to another embodiment, the operating system 540 comprises the UNIX, LINUX, or SOLARIS operating system. It should be appreciated that other operating systems may also be utilized.

The mass storage devices connected to the south bridge 526, and their associated computer storage media, provide non-volatile storage for the computer 502. Although the description of computer storage media contained herein refers to a mass storage device, such as a hard disk or CD-ROM drive, it should be appreciated by those skilled in the art that computer storage media can be any available media that can be accessed by the computer 502.

By way of example, and not limitation, computer storage media may comprise volatile and non-volatile, removable and non-removable media implemented in any method or technology for storage of information such as computer-readable instructions, data structures, program modules or other data. Computer storage media also includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer.

According to embodiments, a low pin count (“LPC”) interface may also be provided by the south bridge 526 for connecting a “Super I/O” device 570. The Super I/O device 570 is responsible for providing a number of input/output ports, including a keyboard port, a mouse port, a serial interface 572, a parallel port, and other types of input/output ports. The LPC interface may also connect a computer storage media such as a ROM or a flash memory such as a NVRAM 548 for storing the firmware 550 that includes program code containing the basic routines that help to start up the computer 502 and to transfer information between elements within the computer 502.

As described briefly above, the south bridge 526 may include a system management bus 564. The system management bus 564 may include a BMC 566. The BMC 566 may be the service processor 102. In general, the BMC 566 is a microcontroller that monitors operation of the computer system 502. In a more specific embodiment, the BMC 566 monitors health-related aspects associated with the computer system 502, such as, but not limited to, the temperature of one or more components of the computer system 502, speed of rotational components (e.g., spindle motor, CPU Fan, etc.) within the system, the voltage across or applied to one or more components within the system 502, and the available or used capacity of memory devices within the system 502. To accomplish these monitoring functions, the BMC 566 is communicatively connected to one or more components by way of the management bus 564. In an embodiment, these components include sensor devices 568 for measuring various operating and performance-related parameters within the computer system 502. The sensor devices 568 may be either hardware or software based components configured or programmed to measure or detect one or more of the various operating and performance-related parameters.

It should also be appreciated that the computer 502 may comprise other types of computing devices, including hand-held computers, embedded computer systems, personal digital assistants, and other types of computing devices known to those skilled in the art. It is also contemplated that the computer 502 may not include all of the components shown in FIG. 5, may include other components that are not explicitly shown in FIG. 5, or may utilize an architecture completely different than that shown in FIG. 5.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a service processor, comprising:
receiving, from a device remotely, a first fingerprint data record of a user and a request to receive a keyboard, video and mouse (KVM) console flow of a host of the service processor;
authenticating the user based on the first fingerprint data record; and
redirecting the KVM console flow to the device when the user is authenticated.

2. The method of claim 1, further comprising rejecting the request when the user is not authenticated.

3. The method of claim 1, wherein the authenticating the user includes: matching the first fingerprint data record with fingerprint data records stored in a data store of the service processor,
wherein the method further comprises: determining that the user is authenticated when the first fingerprint data record matches one of the fingerprint data records stored in the data store.

4. The method of claim 3, wherein the data store is at a local storage device of the service processor.

5. The method of claim 1, wherein the device includes a fingerprint reader, wherein the fingerprint reader generates the first fingerprint data record based on a scan of a finger of the user.

6. The method of claim 1, further comprising: when the user is authenticated, establishing the KVM console flow with the host prior to redirecting the KVM console flow to the device.

7. The method of claim 1, wherein the redirecting the KVM console flow includes:
receiving video data generated at the host through a video stream established between the host and the service processor and sending the video stream to the device through a video stream established between the service processor and the device;
receiving mouse data generated at the device through a mouse stream established between the device and the service processor and sending the mouse data to the host through a mouse stream established between the service processor and the host; and
receiving keyboard data generated at the device through a keyboard stream established between the device and the service processor and sending the keyboard data to the host through a keyboard stream established between the service processor and the host.

8. An apparatus, the apparatus being a service processor, comprising:
a memory; and
at least one processor coupled to the memory and configured to:
receive, from a device remotely, a first fingerprint data record of a user and a request to receive a keyboard, video and mouse (KVM) console flow of a host of the service processor;
authenticate the user based on the first fingerprint data record; and
redirect the KVM console flow to the device when the user is authenticated.

9. The apparatus of claim 8, wherein the at least one processor is further configured to reject the request when the user is not authenticated.

10. The apparatus of claim 8, wherein to authenticate the user, the at least one processor is further configured to: match the first fingerprint data record with fingerprint data records stored in a data store of the service processor,
wherein the at least one processor is further configured to: determine that the user is authenticated when the first fingerprint data record matches one of the fingerprint data records stored in the data store.

11. The apparatus of claim 10, wherein the data store is at a local storage device of the service processor.

12. The apparatus of claim 8, wherein the device includes a fingerprint reader, wherein the fingerprint reader generates the first fingerprint data record based on a scan of a finger of the user.

13. The apparatus of claim 8, wherein, when the user is authenticated, the at least one processor is further configured to establish the KVM console flow with the host prior to redirecting the KVM console flow to the device.

14. The apparatus of claim 8, wherein to redirect the KVM console flow, the at least one processor is further configured to:
receive video data generated at the host through a video stream established between the host and the service processor and sending the video stream to the device through a video stream established between the service processor and the device;
receive mouse data generated at the device through a mouse stream established between the device and the service processor and sending the mouse data to the host through a mouse stream established between the service processor and the host; and
receive keyboard data generated at the device through a keyboard stream established between the device and the service processor and sending the keyboard data to the host through a keyboard stream established between the service processor and the host.

15. A computer-readable medium storing computer executable code for operating a service processor, comprising code to:
receive, from a device remotely, a first fingerprint data record of a user and a request to receive a keyboard, video and mouse (KVM) console flow of a host of the service processor;
authenticate the user based on the first fingerprint data record; and
redirect the KVM console flow to the device when the user is authenticated.

16. The computer-readable medium of claim 15, wherein the code is further configured to reject the request when the user is not authenticated.

17. The computer-readable medium of claim 15, wherein to authenticate the user, the code is further configured to: match the first fingerprint data record with fingerprint data records stored in a data store of the service processor,
wherein the code is further configured to: determine that the user is authenticated when the first fingerprint data record matches one of the fingerprint data records stored in the data store.

18. The computer-readable medium of claim 17, wherein the data store is at a local storage device of the service processor.

19. The computer-readable medium of claim 15, wherein the device includes a fingerprint reader, wherein the fingerprint reader generates the first fingerprint data record based on a scan of a finger of the user.

20. The computer-readable medium of claim 15, wherein, when the user is authenticated, the code is further configured to establish the KVM console flow with the host prior to redirecting the KVM console flow to the device.
